(19) United States
(12) Patent Application Publication
(10) Pub. No.: US 2025/0048214 A1
(43) Pub. Date: Feb. 6, 2025

(54) Network Node, User Equipment and Methods Performed Therein

(71) Applicant: Telefonaktiebolaget LM Ericsson (publ), Stockholm (SE)

(72) Inventors: Afshin Abtin, Sollentuna (SE); Sven Gemski, Solna (SE); Magnus Hallenstål, Täby (SE); Mats Stille, Bromma (SE); Sorin Surdila, Laval (CA)

(21) Appl. No.: 18/717,327

(22) PCT Filed: Jan. 19, 2023
(86) PCT No.: PCT/EP2023/051171

§ 371 Date: Jun. 6, 2024

Related U.S. Application Data
(60) Provisional application No. 63/267,477, filed on Feb. 2, 2022.

(51) Int. Cl. H04W 36/14; H04L 65/1016; H04L 65/1045; H04L 65/1069; H04L 65/1104; H04W 12/037; H04W 12/80

(52) U.S. Cl. CPC H04W 36/14; H04L 65/1016; H04L 65/1045; H04L 65/1069; H04L 65/1104; H04W 12/037; H04W 12/80

(57) ABSTRACT

Embodiments herein relate, for example, to a method performed by a network node (150,13,15) for handling registering to an Internet Protocol Multimedia Subsystem, IMS, network in a communication network. The network node, with the proviso that a user equipment, UE, (10) is performing a handover from a first public land mobile network, PLMN, of a first country or operator to a second PLMN of a second country or operator, performs one or more of the following: —enforcing the UE (10) to make a session initiation protocol, SIP, registration whereby an IMS system can switch off SIP encryption policy, immediately after having entered the second PLMN; —initiating a SIP re-INVITE with a session description protocol, SDP, including a UE subscriber identity, ID, a remote party ID, and an indication of a speech codec; and 7 or —when the network node knows by configuration that the second PLMN requires a different SIP encryption policy than currently used, sending a message to another network node, wherein the message indicates explicitly or implicitly that a different SIP encryption policy and/or LI policy is to be used.

### TECHNICAL FIELD

Embodiments herein relate to a network node, a user equipment (UE), and methods performed therein regarding wireless communication. Furthermore, a computer program product and a computer readable storage medium are also provided herein. In particular, embodiments herein relate to handling handover of UEs between public land mobile networks (PLMN) in a communication network.

### BACKGROUND

In a typical communication network, UEs, also known as wireless communication devices, mobile stations, stations (STA) and/or wireless devices, communicate via a Radio Access Network (RAN) with one or more core networks (CN). The RAN covers a geographical area which is divided into service areas or cells, with each service area or cell being served by a radio network node such as an access node e.g. a Wi-Fi access point or a radio base station (RBS), which in some networks may also be called, for example, a NodeB, a gNodeB, or an eNodeB. The service area or cell is a geographical area where radio coverage is provided by the radio network node. The radio network node operates on radio frequencies to communicate over an air interface with the UEs within range of the radio network node. The radio network node communicates over a downlink (DL) to the UE and the UE communicates over an uplink (UL) to the radio network node.

A Universal Mobile Telecommunications System (UMTS) is a third generation (3G) telecommunication network, which evolved from the second generation (2G) Global System for Mobile Communications (GSM). The UMTS terrestrial radio access network (UTRAN) is essentially a RAN using wideband code division multiple access (WCDMA) and/or High-Speed Packet Access (HSPA) for communication with user equipment. In a forum known as the Third Generation Partnership Project (3GPP), telecommunications suppliers propose and agree upon standards for present and future generation networks and investigate e.g. enhanced data rate and radio capacity. In some RANs, e.g. as in UMTS, several radio network nodes may be connected, e.g., by landlines or microwave, to a controller node, such as a radio network controller (RNC) or a base station controller (BSC), which supervises and coordinates various activities of the plural radio network nodes connected thereto. The RNCs are typically connected to one or more core networks.

Specifications for the Evolved Packet System (EPS) have been completed within the 3GPP and coming 3GPP releases, such as New Radio (NR), are worked on. The EPS comprises the Evolved Universal Terrestrial Radio Access Network (E-UTRAN), also known as the Long-Term Evolution (LTE) radio access network, and the Evolved Packet Core (EPC), also known as System Architecture Evolution (SAE) core network. E-UTRAN/LTE is a 3GPP radio access technology wherein the radio network nodes are directly connected to the EPC core network. As such, the Radio Access Network (RAN) of an EPS has an essentially non-hierarchical architecture comprising radio network nodes connected directly to one or more core networks.

With the emerging 5G technologies such as NR, the use of very many transmit- and receive-antenna elements may be of great interest as it makes it possible to utilize beamforming, such as transmit-side and receive-side beamforming. Transmit-side beamforming means that the transmitter can amplify the transmitted signals in a selected direction or directions, while suppressing the transmitted signals in other directions. Similarly, on the receive-side, a receiver can amplify signals from a selected direction or directions, while suppressing unwanted signals from other directions. NR is connected to the 5G Core Network (5GC) which comprises a number of Network Functions (NF) such as Session Management Function (SMF), Access Management Function (AMF), Authentication Service Function (AUSF), Policy Control Function (PCF), Unified Data Manager (UDM), Network Repository Function (NRF), Network Exposure Function (NEF), just to mention some. In the 5GC, NFs can discover other NFs by using a discovery service provided by the Network Repository Function (NRF).

The Internet Protocol (IP) Multimedia Subsystem (IMS) is a well-known 3GPP standard allowing sessions to be setup between two or more parties for a broad variety of services such as voice or video call, interactive messaging sessions or third-party specific applications. A protocol chosen by 3GPP is the Session Initiation Protocol (SIP). The SIP provides a mechanism for registration of UEs and for setting up multimedia sessions. The SIP REGISTER method enables the registration of user agent's current location and the SIP INVITE method enables the setting up of a session. IMS is implemented by Public Land Mobile Network (PLMN) operators as an architectural framework for delivering IP multimedia services to their subscribers.

Without any seamless mobility between PLMNs of different countries, IMS based roaming would imply that the UE will perform initial EPS Attach/5GS Registration in visiting PLMN (VPLMN), sets up IMS packet data network (PDN) Connection and/or protocol data unit (PDU) session and perform an initial IMS Registration whereby the SIP encryption policy of choice for the operator will be enforced. When seamless mobility is enabled between PLMNs and cross international borders, the IMS Registration is maintained, and a potential ongoing voice call can also be subject for handover and continue cross the border.

Handover of calls within an operator network is well known and commonly used, but international handover of a voice call from a source operator of one country to a target operator network of another country is less known and less deployed. This is in particular applicable to voice over LTE (VoLTE) and/or voice over NR (VoNR) handover (HO) of calls cross international borders.

Handover of calls has great implications on lawful intercept (LI), and this is what is addressed by a multitude of proposed solutions meeting different operator LI obligated demands.

FIG. 1 shows an overview architecture of a communication network. Roaming for IMS based Voice is following a Home routed model where IMS and packet data network gateway (PGW) in 4G and session management function (SMF) in 5G will be in home PLMN (HPLMN), See further in 23.228 v16.0.0 Annex W and Y.9). This model is referred to S8 Home routing in 4G, see GSMA PRD IR.88, and N9HR in 5GS, see GSMA PRD NG.113.

In addition, LI solution for VoLTE and VoNR Roaming is based on VPLMN LI equipment that tap into the VPLMN EPC or 5GC and intercept the SIP and media (voice/video) traffic to enable VPLMN LI, see further in 3GPP TS 33.127 v16.0.0, while Home country will normally depend on the IMS for LI.

### SUMMARY

As part of developing embodiments herein one or more problems have been identified. Since LI for the telephony service in a VPLMN, in other country, is based on “wiretapping” where the serving gateway (SGW) copies what comes on the signalling bearer for IMS, there is a problem with existing solution that the home operator usually defines encryption of SIP signalling messages, referred to as SIP encryption, as home policy between the network and the own subscriber UE at SIP registration time, and this is valid for SIP for any subsequent call until next SIP registration where it may change. Consequently, if such SIP encrypted call is handed over to a foreign country visited PLMN e.g., border Netherlands to Germany, LI in VPLMN cannot intercept the call as it has no clue of who are in the call and even if remaining call SIP messages would be intercepted, those would not be readable to the VPLMN LI system due to the aforementioned SIP encryption.

Another problem is to ensure next call LI, when a UE in idle mode, is moving out of the HPLMN into the VPLMN using the S10 interface, see FIG. 1, between the operators. S10 interface is for EPC between Home mobility management entity (MME) and Visited MME and 5GC, N26 interface is between AMF and MME and N14 interface is for AMF to AMF. SIP encryption can be turned on or off at SIP registration as described above. However, no SIP registration takes place when UE changes PLMN between VPLMN and HPLMN when seamless mobility cross borders is enabled e.g., in idle mobile mobility over S10, or related reference points in 5G. This is due to that the existing connection to the IMS access point name (APN) is retained at mobility to the VPLMN hence there is no reason for the UE to bring up a new connection and make a SIP register. Hence if user makes a call, call set-up SIP signalling will be encrypted and unreadable to a VPLMN LI system.

An object herein is to provide a mechanism to handle communication in an efficient manner to improve performance of a UE in the communication network.

According to an aspect the object is achieved, according to some embodiments herein, by providing a method performed by a network node for handling communication of a UE in a communication network. The network node performs, with the proviso that the UE is performing a handover from a first PLMN of a first country and/or operator to a second PLMN of a second country and/or operator, one or more of the following:
enforces the UE to make a SIP registration whereby an IMS system can switch off SIP encryption policy, immediately after having entered the second PLMN;
initiates a SIP re-INVITE with a session description protocol (SDP) including a UE subscriber ID and a remote party ID and an indication of a speech codec. For example, the network node may initiate sending a SIP re-INVITE with an SDP to the UE with SIP headers including call parties, and SDP media information about a voice codec type and mode used to enable voice interception in case any or both of parties in a call are LI targets in the second country or operator; and/or
when the network node knows by configuration that the second PLMN requires a different SIP encryption policy than currently used, sends a message to another network node, wherein the message indicates explicitly or implicitly that a different SIP encryption policy or LI policy is to be used. The message may be destined an IMS-application server.

The network node may further perform one or more of the following:
when detecting that the UE has changed to the second PLMN, responds with error message to any SIP invite from UE or S-CSCF;
wherein the network node is of the second PLMN and subject to idle mode mobility, receives a TAU request from the UE, and rejects the TAU request with an indication that the UE shall reconnect followed by the establishment of a PDN connection to IMS APN and a new initial SIP registration over said PDN connection;
wherein the network node is of the second PLMN and detecting a voice bearer release, disconnects a PDN connection of the UE with an instruction to the UE to reconnect, this can be done by only releasing the PDN connection with a re-activation request, or by detaching the UE with instruction to re-attach.

According to another aspect the object is achieved, according to some embodiments herein, by providing a method performed by a UE for handling communication of the UE in a communication network. The UE obtains an indication that the UE is or is about to perform a handover from a first PLMN of a first country or operator to a second PLMN of a second country or operator. The UE further, with the proviso that the UE is changing PLMN, initiates a SIP re-register.

It is furthermore provided herein a computer program product comprising instructions, which, when executed on at least one processor, cause the at least one processor to carry out the method above, as performed by the UE or the network node, respectively. It is additionally provided herein a computer-readable storage medium, having stored thereon a computer program product comprising instructions which, when executed on at least one processor, cause the at least one processor to carry out the method according to the method above, as performed by the UE or the network node, respectively.

According to yet another aspect the object is achieved, according to some embodiments herein, by providing a network node for handling communication of a UE in a communication network. The network node is configured to perform, with the proviso that the UE is performing a handover from a first PLMN of a first country and/or operator to a second PLMN of a second country and/or operator, one or more of the following:
enforce the UE to make a SIP registration whereby an IMS system can switch off SIP encryption policy, immediately after having entered the second PLMN;
initiate a SIP re-INVITE with an SDP including a UE subscriber ID and a remote party ID and an indication of a speech codec; and/or
when the network node knows by configuration that the second PLMN requires a different SIP encryption policy than currently used, send a message to another network node, wherein the message indicates explicitly or implicitly that a different SIP encryption policy or LI policy is to be used.

According to still another aspect the object is achieved, according to some embodiments herein, by providing a UE for handling communication of the UE in a communication network. The UE is configured to obtain an indication that the UE is or is about to perform a handover from a first PLMN of a first country or operator to a second PLMN of a second country or operator. The UE is further configured, with the proviso that the UE is changing PLMN, to initiate a SIP re-register.

Embodiments herein disclose methods enabling, for example, to switch off SIP encryption ‘on the fly’ when an ongoing call is handed over from one PLMN on one country and/or operator to another PLMN of another country and/or operator, as well as methods where the system may ensure that the encryption is switched off in due time for the next call after release of the handed over call. Mobility such as Handover and idle mode mobility to a target PLMN network, will be able to intercept the inbound call parties if any being LI target subscribers and thereby will enable to fulfill regulation in a target country or operator. This will thus result in an improved performance of the UE in the communication network.

### BRIEF DESCRIPTION OF THE DRAWINGS

Embodiments will now be described in more detail in relation to the enclosed drawings, in which:

FIG. 1 shows a schematic architecture of a VoLTE session;

FIG. 2 shows an overview depicting a communication network according to embodiments herein;

FIG. 3 shows a flowchart illustrating a method performed by a network node according to embodiments herein;

FIG. 4 shows a flowchart illustrating a method performed by a UE according to embodiments herein;

FIG. 5 shows a signalling scheme according to some embodiments herein;

FIG. 6 shows a signalling scheme according to some embodiments herein;

FIG. 7 shows a signalling scheme according to some embodiments herein;

FIG. 8 shows a signalling scheme according to some embodiments herein;

FIG. 9 shows a signalling scheme according to some embodiments herein;

FIG. 10 shows a signalling scheme according to some embodiments herein;

FIG. 11 shows a signalling scheme according to some embodiments herein;

FIG. 12 shows a signalling scheme according to some embodiments herein;

FIG. 13 shows a signalling scheme according to some embodiments herein;

FIG. 14 shows a signalling scheme according to some embodiments herein;

FIG. 15 shows a block diagram depicting embodiments of a network node according to embodiments herein;

FIG. 16 shows a block diagram depicting embodiments of a UE according to embodiments herein;

FIG. 17 schematically illustrates a telecommunication network connected via an intermediate network to a host computer;

FIG. 18 is a generalized block diagram of a host computer communicating via a base station with a user equipment over a partially wireless connection; and

FIGS. 19, 20, 21, and 22 are flowcharts illustrating methods implemented in a communication system including a host computer, a base station and a user equipment.

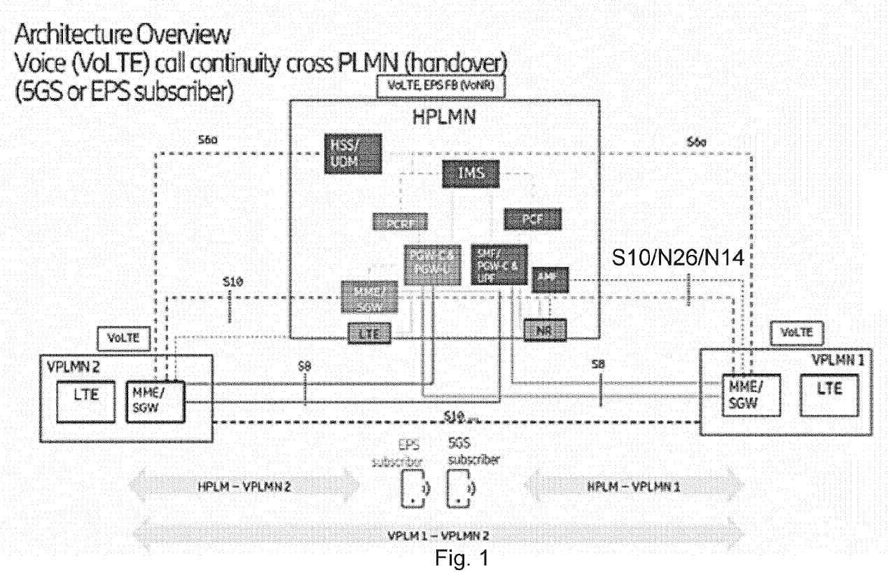

### DETAILED DESCRIPTION

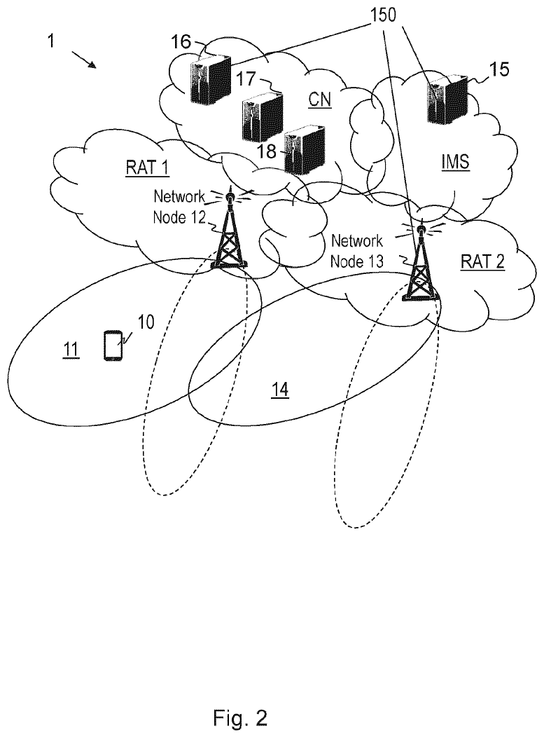

Embodiments herein relate to communication networks in general. FIG. 2 is a schematic overview depicting a communication network 1. The communication network 1 comprises one or more RANs and one or more CNs. The communication network 1 may use one or a number of different technologies. Embodiments herein relate to recent technology trends that are of particular interest in a New Radio (NR) context, however, embodiments are also applicable in further development of existing wireless communications systems such as e.g. LTE or Wideband Code Division Multiple Access (WCDMA).

In the communication network 1, a user equipment (UE) 10 exemplified herein as a wireless device such as a mobile station, a non-access point (non-AP) station (STA), a STA and/or a wireless terminal, is comprised communicating via e.g. one or more Access Networks (AN), e.g. radio access network (RAN), to one or more core networks (CN). It should be understood by the skilled in the art that “UE” is a non-limiting term which means any terminal, wireless communications terminal, user equipment, narrowband internet of things (NB-IoT) device, Machine Type Communication (MTC) device, Device to Device (D2D) terminal, or node e.g. smart phone, laptop, mobile phone, sensor, relay, mobile tablets or even a small base station capable of communicating using radio communication with a radio network node within an area served by the radio network node.

The communication network 1 comprises a first radio network node 12 or just radio network node, providing radio coverage over a geographical area, a first service area 11 or first cell, of a first radio access technology (RAT), such as NR, LTE, or similar. The radio network node 12 may be a transmission and reception point such as an access node, an access controller, a base station, e.g. a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), a transmission arrangement of a radio base station, a stand-alone access point or any other network unit or node capable of communicating with a UE within the area served by the first radio network node depending e.g. on the first radio access technology and terminology used. The first radio network node may be referred to as a serving radio network node wherein the service area may be referred to as a serving cell, and the serving network node communicates with the wireless device in form of DL transmissions to the wireless device and UL transmissions from the wireless device. It should be noted that a service area may be denoted as cell, beam, beam group or similar to define an area of radio coverage. The first radio network node 12 may be of a first PLMN such as a HPLMN.

The communication network 1 comprises a second radio network node 13 or just radio network node, providing radio coverage over a geographical area, a second service area 14 or second cell, of a second radio access technology (RAT), such as NR, LTE, or similar. The second radio network node 13 may be a transmission and reception point such as an access node, an access controller, a base station, e.g. a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), a transmission arrangement of a radio base station, a stand-alone access point or any other network unit or node capable of communicating with a wireless device within the area served by the second radio network node depending e.g. on the first radio access technology and terminology used. The second radio network node may be referred to as a visiting radio network node or target radio network node, wherein the service area may be referred to as a visiting cell or target cell, and the second radio network node communicates with the UE in form of DL transmissions to the UE and UL transmissions from the UE. It should be noted that a service area may be denoted as cell, beam, beam group or similar to define an area of radio coverage. The second radio network node 13 may be of a second PLMN such as a VPLMN.

The communication network may comprise an IMS network comprising one or more IMS nodes 15. Thus, the IMS network may comprise several network entities, some of which are discussed here. Each PLMN may have it own IMS, a first IMS node at the first PLMN and a second IMS node at the second PLMN.

An IMS node may comprise one of the following:
A Home Subscriber Server (HSS); an HSS is a subscriber database comprising subscriber profiles, performs authentication and authorization, and provides information on services provisioned for subscribers and information on the location and IP address of a subscriber.
A Serving Call Session Control Function (S-CSCF); an S-CSCF is a SIP server and is the central signaling node in the IMS network and performs session control services for the UE. It handles SIP registrations and is responsible for forwarding SIP messages to the correct application server. The S-CSCF may behave as a SIP-proxy, i.e. it accepts requests and services them internally or forwards them.
Another entity is an outbound proxy of the UE 10, which is referred to as a Proxy-Call/Session Control Function (P-CSCF). The P-CSCF routes requests to other CSCFs such as S-CSCFs.
Interrogating Call Session Control Function (I-CSCF); an I-CSCF is a SIP server and located at the edge of an administrative domain. Its IP address is published in the Domain Name System (DNS) of the domain, so that remote servers can find it and use it as a forwarding point for SIP packets to this domain.

The communication network 1 may further comprise a number of core network nodes providing, e.g. in NR, network functions (NF) or actually instantiations of NFs also referred to as NF instances, such as a first network node 16 providing, for example, an instantiation of a session management function (NRF), a second network node 17 providing an instantiation of an AMF, and a third network node 18 providing, for example, an instantiation of an SMF, or any other NF instances in the communication network 1. The different NF instances may have different tasks. Other functions may be for LTE such as MME or similar.

The respective node may be a standalone server, a cloud-implemented server, a distributed server or processing resources in a server farm or same node. Embodiments herein may be implemented as physical bare metal, virtual or cloud native such as Kubernetes environment in e.g. hyper-cloud networks.

A mechanism is herein provided to use the awareness of a UE PLMN change, to initiate certain procedures that ensures the VPLMN LI system can intercept either the ongoing handed over call, or the next call after release of the handed over call. Thus, embodiments herein may relate to enable a target PLMN receiving a handed-over call from a source network of another operator, to process LI on that call, or at the next call.

Embodiments herein disclose, for example, a network node 150, such as an IMS node, a radio network node or a NF node, with the proviso that the UE 10 is performing a handover from a first PLMN of a first country and/or operator to a second PLMN of a second country and/or operator, performs one or more of the following:
enforces the UE 10 to make a SIP registration whereby an IMS system can switch off SIP encryption policy, immediately after having entered the second PLMN;
initiates a SIP re-INVITE with an SDP including a UE subscriber ID and a remote party ID and an indication of a speech codec. The re-invite signal carries an SDP that describes type of media, media bandwidth, codec etc; and/or
when the network node 150 knows by configuration that the second PLMN requires a different SIP encryption policy than currently used, sends a message to another network node, wherein the message indicates explicitly or implicitly that a different SIP encryption policy or LI policy is to be used. The various solutions described herein, have some common components. These are:
Detection of PLMN change in IMS and propagating of this by a SIP MESSAGE
Change of the SIP encryption policy at mobility between PLMNs based on the operator policy. This may be for an ongoing call or for next call after the mobility. The mobility may be a connected mode mobility (handover) or idle mode mobility.
Providing VPLMN LI system with subscriber identities mid-call for interception of an ongoing calls from HPLMN IMS system to VPLMN LI system using SIP signaling such as a Re-INVITE.

The mechanism to change the status of SIP encryption may be performed during an IMS Registration. There are various ways to achieve this, e.g.:
Enforce the UE 10 to perform an IMS Re-register or a new initial IMS Registration, enforced by the network (NW) such as a network node. This can be done on
   IMS layer, (see sections 5.1.1.1, 5.2.2 below)
   IMS layer to trigger Packet Core layer procedure or (See sections 5.1.2.1, 5.2.1 below)
   directly by packet core (MME or AMF/SMF) (See sections 5.1.2.2, 5.2.3 below)
Enhance UEs to perform a SIP re-registration at PLMN change (see section 5.1.1.2, 5.2.4 below)

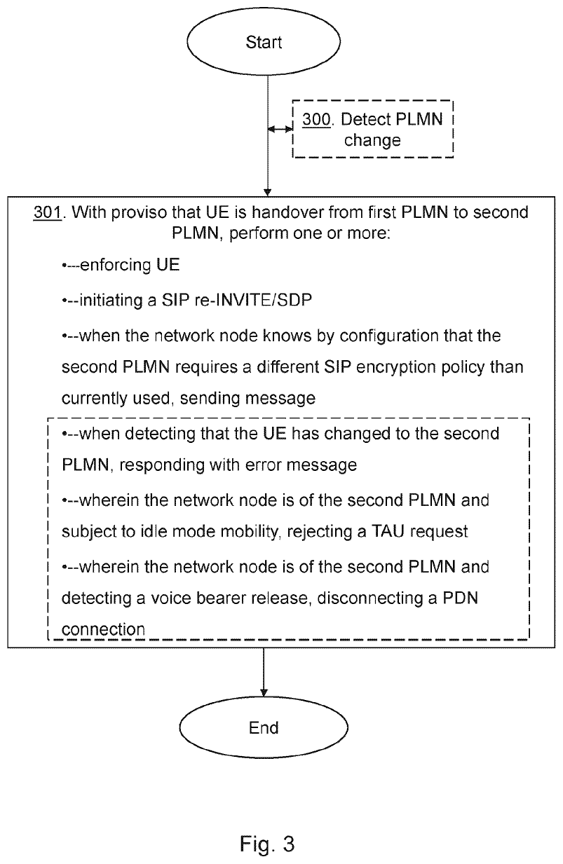

The method actions performed by the network node 150, such as the IMS node 15, the second network node 13 or another network node, for handling SIP signalling in the communication network, for example, handling registering to an IMS network, according to embodiments herein will now be described with reference to a flowchart depicted in FIG. 3. The actions do not have to be taken in the order stated below, but may be taken in any suitable order. Actions performed in some embodiments are marked with dashed boxes.
Action 300. The network node 150 may detect a PLMN change for the UE 10.
Action 301. With the proviso that the UE 10 is performing a handover from a first PLMN of a first country or operator to a second PLMN of a second country or operator, the network node 150 performs one or more of the following:
   enforcing the UE 10 to make a SIP registration whereby an IMS system can switch off SIP encryption policy, immediately after having entered the second PLMN.
   initiating a SIP re-INVITE with SDP including a UE subscriber ID and a remote party ID and an indication of a speech codec. For example, the network node may initiate sending a SIP re-INVITE with SDP to the UE 10 with SIP headers including the call parties, and SDP media information about the voice codec type and mode used to enable voice interception in case any or both of parties in a call are LI targets in the second country or operator. This may be for interception of both voice media and signalling, or to provide signalling information to enable voice media interception.
   when the network node 150 knows by configuration that the second PLMN (the changed-to PLMN) requires a different SIP encryption policy than currently used, sending a message to another network node, wherein the message indicates explicitly or implicitly that a different SIP encryption policy and/or LI policy is to be used. The message may be destined an IMS-application server. The message may e.g., comprise directive on LI policy to us, e.g., do a P-CSCF restoration, or do a UE Re-authentication.

The network node 150 may further perform one or more of the following:
when detecting that the UE 10 has changed to the second PLMN, responding with error message to any SIP invite from UE or S-CSCF.
wherein the network node 150 is of the second PLMN and subject to idle mode mobility, receiving a TAU request from the UE 10, and rejecting the TAU request with an indication that the UE 10 shall reconnect followed by the establishment of a PDN connection to IMS APN and a new initial SIP registration over said PDN connection.
wherein the network node 150 is of the second PLMN and detecting a voice bearer release, disconnecting a PDN connection of the UE 10 with an instruction to the UE 10 to reconnect, this can be done by only releasing the PDN connection with a re-activation request, or by detaching the UE 10 with instruction to re-attach.

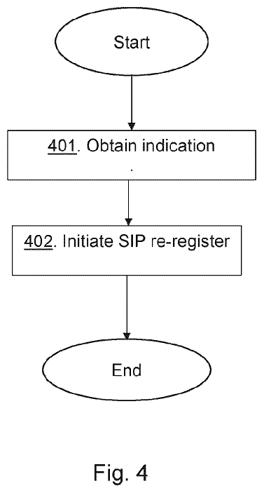

The method actions performed by the UE 10 for handling communication of the UE 10 in the communication network, for example, handling handover, according to embodiments herein will now be described with reference to a flowchart depicted in FIG. 4. The actions do not have to be taken in the order stated below, but may be taken in any suitable order. Actions performed in some embodiments are marked with dashed boxes.
Action 401. The UE 10 obtains an indication that the UE 10 is or is about to perform a handover from the first PLMN of the first country or operator to the second PLMN of the second country or operator. For example, the UE 10 may determine that it is performing the HO, or receive indication from network node 150.
Action 402. With the proviso that the UE 10 is changing PLMN, the UE 10 initiates a SIP re-register. Thus, it is a UE enforced SIP re-register at detection of PLMN change.

### Signaling Procedures.

### 5.1 Connected Mode Mobility

### 5.1.1 Ongoing Call LI

### 5.1.1.1 Enable VPLMN LI for Ongoing Call, NW Triggered

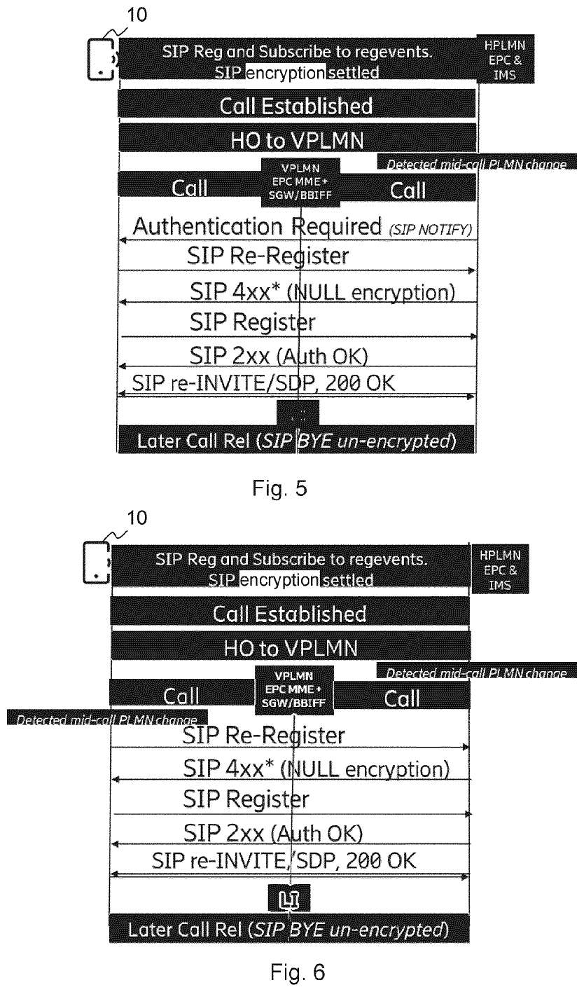

See FIG. 5.

When IMS node gets notified by packet core PCRF/PCF about PLMN change (IMS has subscribed to it), the IMS node checks if a call is ongoing and if that is the case, the IMS node will initiate sending of a request to the UE 10 to re-authenticate itself (SIP NOTIFY). When the UE 10 responds by making a SIP re-register, the IMS node will set off SIP encryption. This means any remaining SIP signal e.g., SIP BYE, is readable to VPLMN LI system. To make VPLMN LI aware of who the call parties are, the IMS node may initiate e.g., a SIP re-INVITE with SDP including the UE subscriber ID and remote party ID and speech codec. These three components enable the VPLMN LI system to intercept voice if any of the call parties are subject to VPLMN country LI.

SDP describes media flows like address, port, media type, encoding etc.

Such action could be made by a P-CSCF when it knows by configuration that the changed-to PLMN requires a different SIP encryption policy, e.g., NULL encryption, than currently used e.g., full, by sending e.g., a SIP MESSAGE via S-CSCF destined an IMS-AS including a directive to S-CSCF e.g., by means of a SIP header, SIP body or other, to cause a UE re-authentication e.g., by SIP NOTIFY.

### 5.1.1.2 Enable VPLMN LI for Ongoing Call, UE Triggered

See FIG. 6.

When the UE 10 detects it has changed PLMN during the call, it sends a SIP re-register request to the network. When the network receives it, the IMS node may set off SIP encryption by proposing null encryption in the SIP 4xx message part of the SIP re-registration procedure, if so configured for the VPLMN.

This means that any remaining SIP signal, e.g., SIP BYE, is readable to VPLMN LI system. To make VPLMN LI aware of who the call parties are, the IMS node may initiate a SIP re-INVITE with SDP including the UE subscriber ID and remote party ID and speech codec. These three components enable the VPLMN LI system to intercept voice if any of the call parties is subject to VPLMN country LI.

5.1.1.3 Enable VPLMN LI for an Ongoing Call without SIP Encryption.

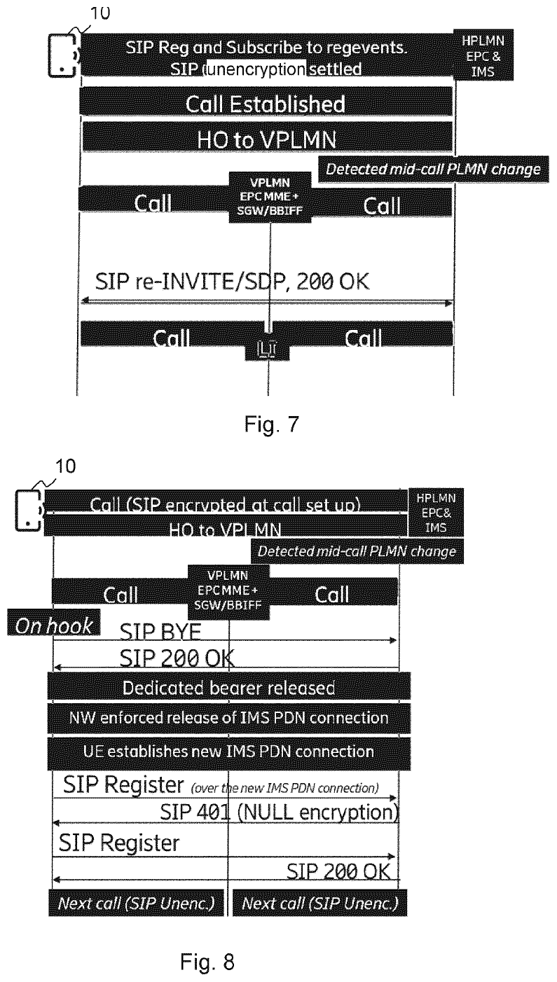

See FIG. 7.

If the HPLMN operator never uses SIP encryption hence never sets it upon a UE SIP register, the VPLMN LI system will be able to read the remaining SIP signals of a handed over call. However, the home network has to provide information about who are the call parties and what voice codec is used, since this is unknown to the VPLMN as it was not involved in the original call set up.

For this reason, the HPLMN IMS network, such as the network node, may initiate sending a SIP re-INVITE with SDP to the UE 10 with SIP headers including the call parties, and SDP media information about the voice codec type and mode used to enable voice interception in case any or both of the parties are LI targets in the VPLMN country.

Such initiative could be made by a P-CSCF—when it knows by configuration that the changed-to PLMN requires a different SIP encryption policy e.g. NULL, than currently used e.g., full, sending e.g. a SIP MESSAGE destined an IMS-AS including a directive by means of a SIP header, SIP body, or other, to cause a SIP re-INVITE with current call information with regards to parties and codec.

5.1.2 Next Call, after Handed Over Call is Released, LI

### 5.1.2.1 Enable VPLMN LI for Next Call, IMS Triggered Release of PDN Connection See FIG. 8.

If two operators can agree that the ongoing handed over call need not be subject to VPLMN at all, but only the next one, the HPLMN IMS network can, upon PLMN detection as of a notification from packet core PCRF/PCF to IMS P-CSCF, initiate a release of IMS PDN connection/PDU session with reactivation indication leading to teardown of the existing IMS PDN connection/PDU Session and a UE Initiated SIP initial register, when the call is over in order to avoid call drop. Such initiative could be made by a P-CSCF-when it knows by configuration that the changed-to PLMN requires a different SIP encryption policy e.g. NULL, than currently used, e.g., full, sending, e.g., a SIP MESSAGE destined an IMS-application server (AS) via S-CSCF including a directive by means of a SIP header or SIP body, to cause said PDN Connection/PDU Session reactivation needed at call release, over Cx/N70 interface with home subscriber server (HSS).

IMS node may trigger the PDN connection/PDU session release with re-activation in EPC/5GC by means of the P-CSCF restoration procedure.

Alternatively, the network node such as a P-CSCF can respond with SIP 500 error, to any subsequent SIP Invite from the UE 10 or a S-CSCF causing either the UE 10 to register to a new P-CSCF with or without a new PDN connection/PDU session or the S-CSCF to trigger a P-CSCF restoration procedure. A subsequent SIP register may result in change of SIP encryption. This method can be done for idle mobility, where when the P-CSCF detects UE 10 has changed to a different PLMN, the P-CSCF responds with SIP 500 to any SIP invite from the UE or the S-CSCF. Thus, responding with 500 due to a PLMN change has been detected.

### 5.1.2.2 Enable VPLMN LI for Next Call, MME Triggered Release of IMS PDN Connection.

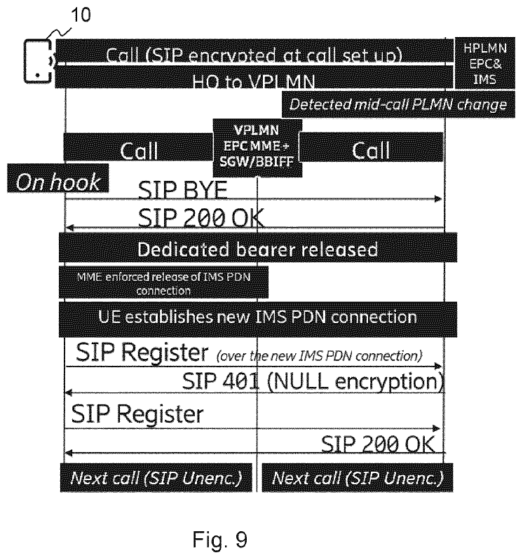

See FIG. 9.

When a target MME of a new target PLMN subject to an Si based inter-PLMN handover over an S10 interface, detects voice bearer release, the target MME may disconnect the PDN connection with an instruction to the UE 10 to reconnect, this can be done by only releasing the PDN connection with a re-activation request, or by detaching the UE 10 with instruction to re-attach. This will result in new establishment of a PDN connection to the IMS APN and a new initial SIP registration over said PDN connection. The IMS node may set the relevant SIP encryption method as of that target PLMN to ensure proper LI. This ensures VPLMN LI at the next call.

The solution is applicable to 5GC as well by SMF (5G PDU Session release).

### 5.2 Idle Mode Mobility

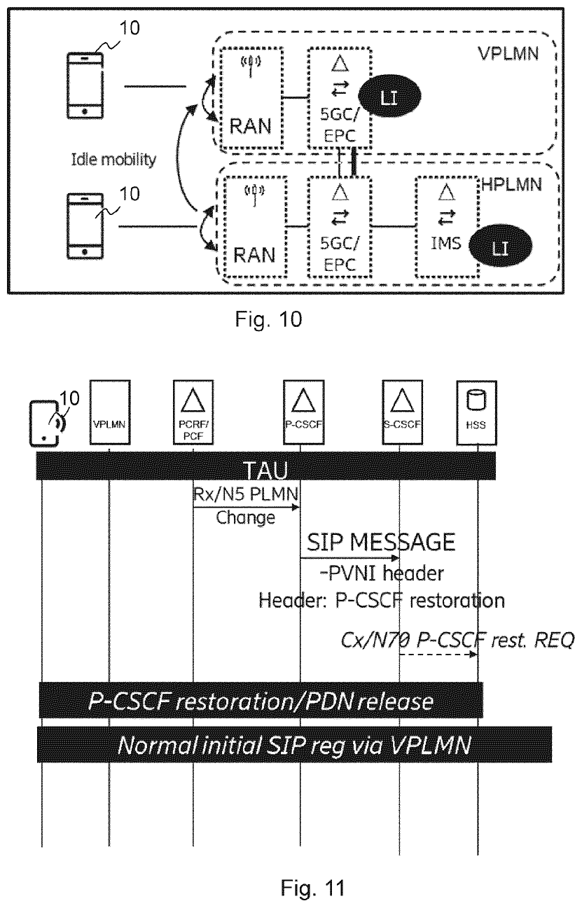

See FIG. 10.

When two operators have an S10/N26/N14 interface between them for the sake of international handover, it can be used by the UE 10 for international mobility in idle mode (in no call position), with the need to make a SIP re-registration from the new visited PLMN since the IP address is retained as provided by the HPLMN packet core IMS PDN connection gateway at the latest SIP register.

The solution is based on enforcing the UE 10 to make a SIP registration whereby the HPLMN IMS system can switch off SIP encryption policy, immediately after having entered the new PLMN. Otherwise, there is a risk that a UE makes or receives a call which the VPLMN LI system cannot intercept as it would be unreadable SIP signals exchanged to establish the call.

5.2.1 PDN Connection/PDU Session Reactivation Method after Idle Mode PLMN Change Detection.

As seen in the FIG. 11, the IMS node may detect the UE's idle mode mobility cross PLMN. This is done by means of a PLMN change notification from packet core PCRF/PCF to IMS P-CSCF.

The P-CSCF may now initiate a P-CSCF restoration in order to teardown the IMS PDN connection/PDU session that the idle mode UE is using, forcing it to make a new attach, set up a new IMS PDN connection and make a SIP register over said connection, whereby the P-CSCF receiving the SIP register, may define SIP encryption to be switched off/NULL during the SIP register procedure.

Such initiative could be made by the P-CSCF—when it knows by configuration that the changed-to PLMN requires a different SIP encryption policy e.g. NULL, than currently used e.g full by e.g. a SIP MESSAGE destined S-CSCF e.g. using service-route uniform resource identifier (URI) as received from S-CSCF in the latest SIP registration, as request URI, or equivalent. This restoration is the same as described in 5.1.2.1. A detail that differs is that the SIP MESSAGE in 5.1.2.1 is destined an IMS-AS, whereas left case, it is destined the S-CSCF directly.

Such MESSAGE or equivalence may include a directive by means of a SIP header, SIP body or no directive at all in case the S-CSCF has a preconfigured knowledge about which LI action to take such as causing a P-CSCF restoration.

5.2.2 Network Initiated UE Re-Authentication after Idle Mode PLMN Change Detection

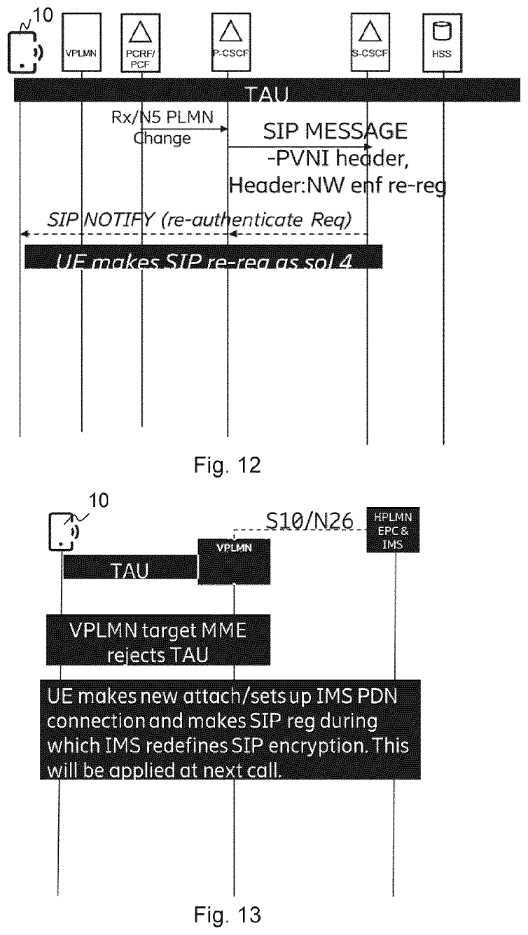

As seen in FIG. 12, the IMS node may detect the UE's idle mode mobility cross PLMN. This is done by means of a PLMN change notification from packet core PCRF/PCF to IMS P-CSCF.

The IMS node may initiate sending of a request to the UE 10 to re-authenticate itself (SIP NOTIFY). When the UE 10 responds by making a SIP re-register, the IMS node may set off SIP encryption. This means that the next originated or terminating call with the UE 10, will be readable to VPLMN LI system. See FIG. 5 at 5.1.1. (NW enforced SIP re-reg).

Such initiative could be made by the P-CSCF-when it knows by configuration that the changed-to PLMN requires a different SIP encryption policy e.g., NULL, than currently used e.g., full, sending a e.g., SIP MESSAGE or equivalence addressed to S-CSCF e.g., reusing the S-CSCF address that P-CSCF obtained in the service-route header during the latest SIP register, from S-CSCF. The message may contain a directive by means of a SIP header, SIP body to S-CSCF about the wanted re-authentication of the UE 10. Or, no directive at all in case S-CSCF can use any pre-configured information about what to do upon reception of such S-CSCF addressed SIP MESSAGE with PVNI header containing the new PLMN ID (MCC/MNC combination). This re-authentication is the same as described in 5.1.1.1. A detail that differs is that the SIP MESSAGE in 5.1.1.1 is destined an IMS-AS, whereas left case, it is destined the S-CSCF directly.

5.2.3 Target MME Rejecting Tracking Area Update (TAU) after PLMN Change Detection.

See FIG. 13.

When the target MME of a new target PLMN (VPLMN for example in FIG. 13) subject to idle mode mobility over an S10 interface, receives a TAU request from the UE 10, the target MME can reject the TAU request with an indication that the UE 10 shall reconnect i.e., make an initial attach, followed by the establishment of a PDN connection to IMS APN and a new initial SIP registration over said PDN connection. The IMS node may set the relevant SIP encryption method as of that target PLMN to ensure proper LI. This ensures VPLMN LI at the next call. Note that this is done for all calls.

The solution is applicable to 5GC as well by AMF (corresponding TAU, 5GC Register).

An Option could be that MME accepts the TAU, but disconnects the IMS PDN connection afterwards.

The solution is applicable to 5GC as well by SMF (release of corresponding PDU Conn, the 5G PDU Session).

### 5.2.4 UE Enforced SIP Re-Register at Detection of PLMN Change

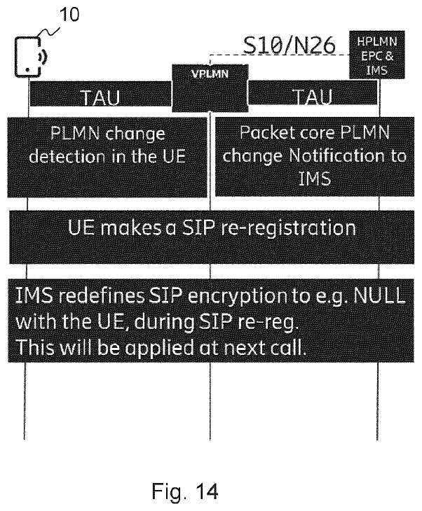

As seen in FIG. 14, the UE 10 detects a PLMN change reading the new PLMN ID as of known radio network broadcast technology.

This can make the UE 10 to initiate a SIP re-register, and the IMS node may set off SIP encryption similar to if this had been an ongoing call case as in 5.1.1.2. This means that the next originated or terminating call with the UE 10, will be readable to VPLMN LI system. This UE initiated SIP re-reg upon UE detection of changed PLMN to new country, is in essence the same as described in 5.1.1.2, where a difference is that the UE 10 does the re-reg when there is no call ongoing. Difference for NW is that IMS node does not send re-INVITE to the UE 10 with call part is IDs and codec since there is no ongoing call.

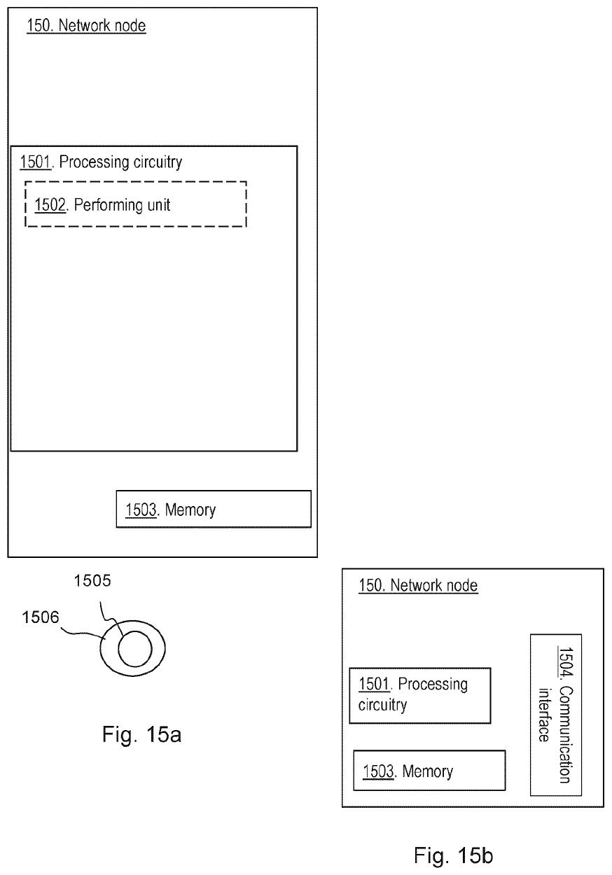

FIG. 15a-15b are block diagrams depicting the network node 150 in two embodiments for handling communication of the UE 10 in the communication network 1 according to embodiments herein.

The network node 150 may comprise processing circuitry 1501, e.g., one or more processors, configured to perform the methods herein.

The network node 150 may comprise a performing unit 1502, e.g., a transmitter or a transceiver. The network node 150, the processing circuitry 1501, and/or the performing unit 1502 is configured to perform, with the proviso that the UE 10 is performing the handover from the first PLMN of the first country or operator to the second PLMN of the second country or operator, one or more of the following:
enforcing the UE 10 to make a SIP registration whereby an IMS system can switch off SIP encryption policy, immediately after having entered the second PLMN.
initiating a SIP re-INVITE with an SDP including a UE subscriber ID and a remote party ID and an indication of a speech codec.
initiating sending a SIP re-INVITE with an SDP to the UE 10 with SIP headers including the call parties, and SDP media information about the voice codec type and mode used to enable voice interception in case any or both of parties in a call are LI targets in the second country or operator.
when the network node knows by configuration that the second PLMN requires a different SIP encryption policy than currently used, sending a message to another network node, wherein the message indicates explicitly or implicitly that a different SIP encryption policy and/or LI policy is to be used. The message may be destined an IMS-application server.

The network node 150, the processing circuitry 1501, and/or the performing unit 1502 may be configured to perform one or more of the following:
when detecting that the UE 10 has changed to the second PLMN, responding with error message to any SIP invite from UE or S-CSCF.
wherein the network node is of the second PLMN and subject to idle mode mobility, receiving a TAU request from the UE, and rejecting the TAU request with an indication that the UE shall reconnect followed by the establishment of a PDN connection to IMS APN and a new initial SIP registration over said PDN connection.
wherein the network node is of the second PLMN and detecting a voice bearer release, disconnecting a PDN connection of the UE with an instruction to the UE to reconnect, this can be done by only releasing the PDN connection with a re-activation request, or by detaching the UE with instruction to re-attach.
The network node 150 may be configured to detect a PLMN change for the UE (10).

The network node 150 may comprise a memory 1503. The memory 1503 comprises one or more units to be used to store data on, such as data packets, PLMN IDs, SDP, IDs, messages, thresholds, events and applications to perform the methods disclosed herein when being executed, and similar. Furthermore, the network node 150 may comprise a communication Interface 1504 such as comprising a transmitter, a receiver, a transceiver and/or one or more antennas.

The methods according to the embodiments described herein for the network node 150 are respectively implemented by means of e.g., a computer program product 1505 or a computer program, comprising instructions, i.e., software code portions, which, when executed on at least one processor, cause the at least one processor to carry out the actions described herein, as performed by the network node 150. The computer program product 1505 may be stored on a computer-readable storage medium 1506, e.g., a disc, a universal serial bus (USB) stick or similar. The computer-readable storage medium 1506, having stored thereon the computer program product, may comprise the instructions which, when executed on at least one processor, cause the at least one processor to carry out the actions described herein, as performed by the network node 150. In some embodiments, the computer-readable storage medium may be a transitory or a non-transitory computer-readable storage medium. Thus, embodiments herein may disclose the network node for handling communication in a communication network, wherein the network node comprises processing circuitry and a memory, said memory comprising instructions executable by said processing circuitry whereby said network node is operative to perform any of the methods herein.

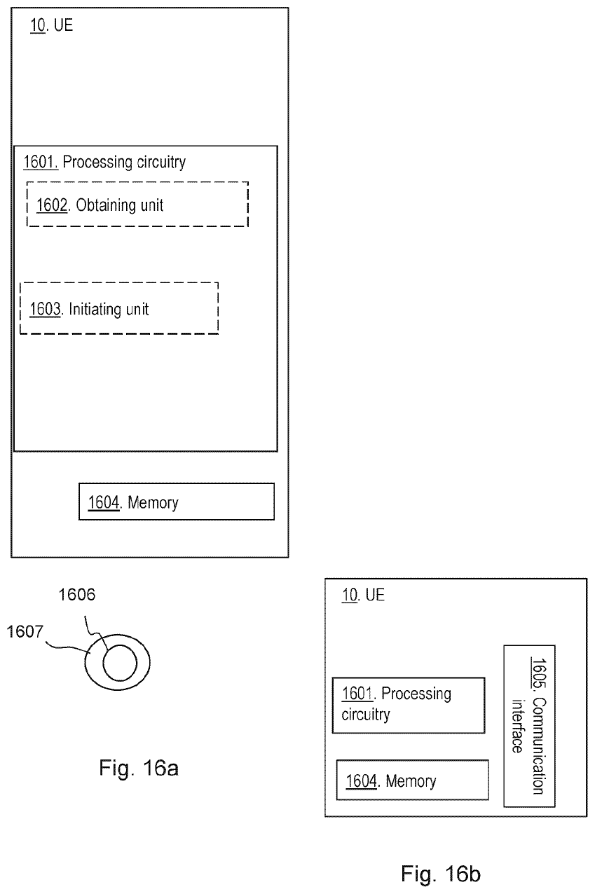

FIGS. 16a-16b are block diagrams depicting the UE 10, in two embodiments, for handling communication in the communication network 1 according to embodiments herein.

The UE 10 may comprise processing circuitry 1601, e.g., one or more processors, configured to perform the methods herein.

The UE 10 may comprise an obtaining unit 1602, e.g., a receiver or transceiver. The UE 10, the processing circuitry 1601, and/or the obtaining unit 1602 is configured to obtain the indication that the UE is or is about to perform a handover from the first PLMN of the first country or operator to the second PLMN of the second country or operator. For example, configured to determine that it is performing the HO, or to receive indication from network node.

The UE 10 may comprise an Initiating unit 1603, such as a transmitter or transceiver. The UE 10, the processing circuitry 1601, and/or the initiating unit 1603 is configured, with the proviso that the UE is changing PLMN, to initiate the SIP re-register. Thus, it is a UE enforced SIP re-register at detection of PLMN change.

The UE 10 may comprise a memory 1604. The memory 1604 comprises one or more units to be used to store data on, such as data packets, thresholds, signal strengths/qualities, measurements, indications, PLMN IDs, SIP messages, events and applications to perform the methods disclosed herein when being executed, and similar. Furthermore, the UE 10 may comprise a communication Interface 1605 such as comprising a transmitter, a receiver, a transceiver and/or one or more antennas.

The methods according to the embodiments described herein for the UE 10 are respectively implemented by means of e.g., a computer program product 1606 or a computer program, comprising instructions, i.e., software code portions, which, when executed on at least one processor, cause the at least one processor to carry out the actions described herein, as performed by the UE 10. The computer program product 1606 may be stored on a computer-readable storage medium 1607, e.g., a disc, a universal serial bus (USB) stick or similar. The computer-readable storage medium 1607, having stored thereon the computer program product, may comprise the instructions which, when executed on at least one processor, cause the at least one processor to carry out the actions described herein, as performed by the UE 10. In some embodiments, the computer-readable storage medium may be a transitory or a non-transitory computer-readable storage medium. Thus, embodiments herein may disclose a UE 10 for handling communication in a communication network, wherein the UE 10 comprises processing circuitry and a memory, said memory comprising instructions executable by said processing circuitry whereby said UE 10 is operative to perform any of the methods herein.

In some embodiments a more general term “network node” is used and it can correspond to any type of radio-network node or any network node, which communicates with a UE and/or with another network node.

In some embodiments the non-limiting term wireless device or user equipment (UE) is used and it refers to any type of wireless device communicating with a network node and/or with another wireless device in a cellular or mobile communication system. Examples of UE are target device, device to device (D2D) UE, proximity capable UE (aka ProSe UE), IoT capable device, machine type UE or UE capable of machine to machine (M2M) communication, Tablet, mobile terminals, smart phone, laptop embedded equipped (LEE), laptop mounted equipment (LME), USB dongles etc.

Embodiments are applicable to any RAT or multi-RAT systems, where the wireless device receives and/or transmit signals (e.g. data) e.g. NR, Wi-Fi, LTE, LTE-Advanced, Wideband Code Division Multiple Access (WCDMA), Global System for Mobile communications/enhanced Data rate for GSM Evolution (GSM/EDGE), Worldwide Interoperability for Microwave Access (WIMax), or Ultra Mobile Broadband (UMB), just to mention a few possible implementations.

As will be readily understood by those familiar with communications design, that functions means or circuits may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware and/or program or application data. Other hardware, conventional and/or custom, may also be included. Designers of communications devices will appreciate the cost, performance, and maintenance trade-offs inherent in these design choices.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

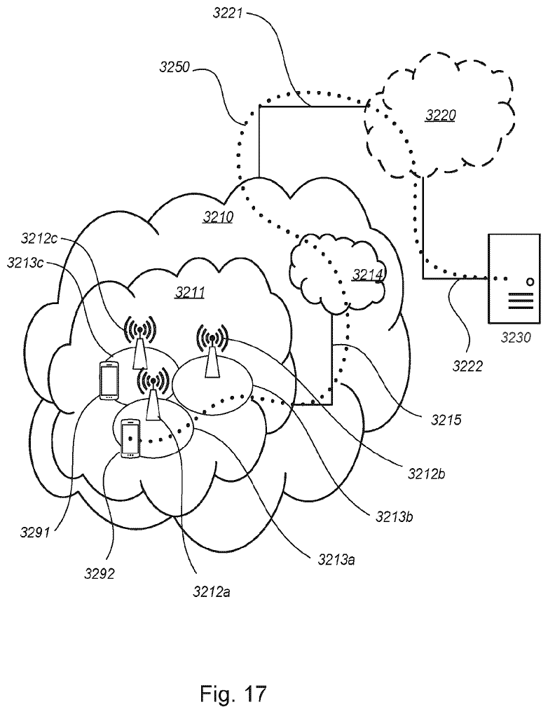

With reference to FIG. 17, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points being examples of the radio network node 12 herein, each defining a corresponding coverage area 3213a, 3213b, 3213c. Each base station 3212a, 3212b, 3212c is connectable to the core network 3214 over a wired or wireless connection 3215. A first user equipment (UE) 3291, being an example of the UE 10, located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 17 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

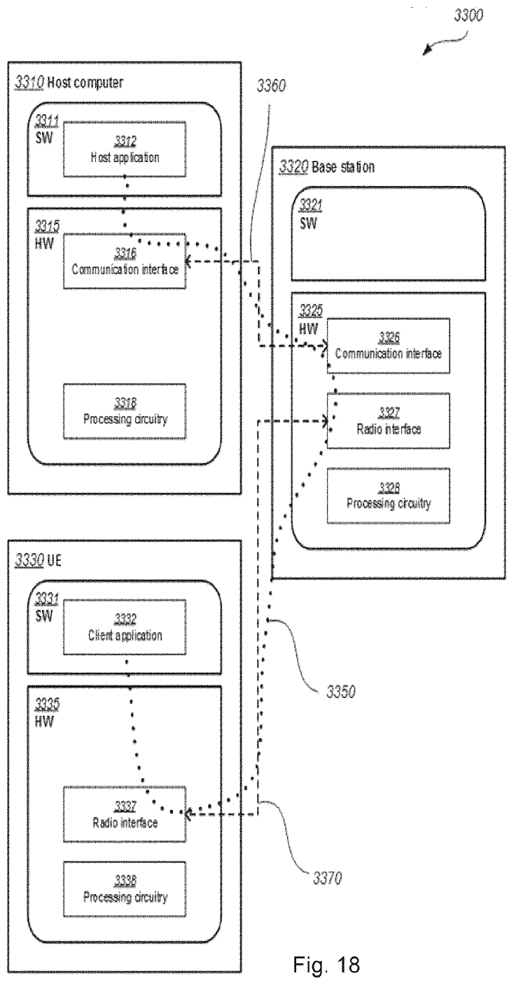

Example implementations, in accordance with an embodiment, of the UE, base station and host computer discussed in the preceding paragraphs will now be described with reference to FIG. 18. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 18) served by the base station 3320. The communication interface 3326 may be configured to facilitate a connection 3360 to the host computer 3310. The connection 3360 may be direct or it may pass through a core network (not shown in FIG. 18) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 18 may be identical to the host computer 3230, one of the base stations 3212a, 3212b, 3212c and one of the UEs 3291, 3292 of FIG. 17, respectively. This is to say, the inner workings of these entities may be as shown in FIG. 18 and independently, the surrounding network topology may be that of FIG. 17.

In FIG. 18, the OTT connection 3350 has been drawn abstractly to illustrate the communication between the host computer 3310 and the user equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the performance since handover to another PLMN may be handled more efficiently and thereby provide benefits such as reduced user waiting time, and better responsiveness.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

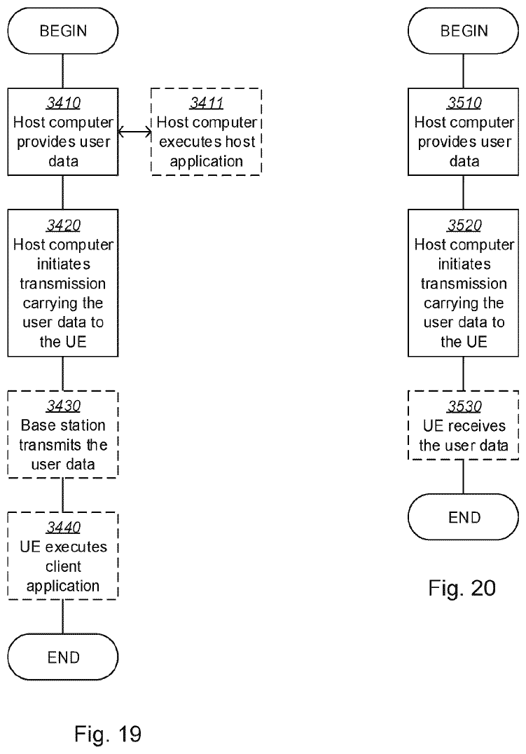

FIG. 19 is a flowchart illustrating a method implemented in a communication system, in accordance with one embodiment. The communication system includes a host computer, a base station and a UE which may be those described with reference to FIGS. 17 and 18. For simplicity of the present disclosure, only drawing references to FIG. 19 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 20 is a flowchart illustrating a method implemented in a communication system, in accordance with one embodiment. The communication system includes a host computer, a base station and a UE which may be those described with reference to FIGS. 17 and 18. For simplicity of the present disclosure, only drawing references to FIG. 20 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

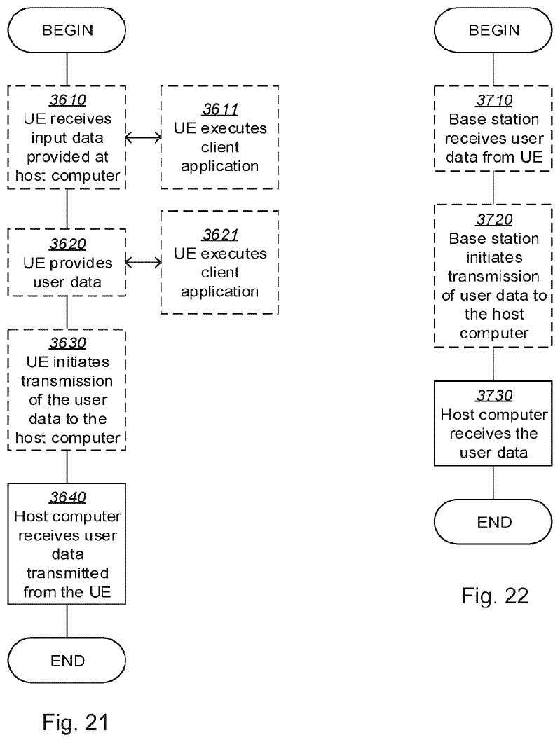

FIG. 21 is a flowchart illustrating a method implemented in a communication system, in accordance with one embodiment. The communication system includes a host computer, a base station and a UE which may be those described with reference to FIGS. 17 and 18. For simplicity of the present disclosure, only drawing references to FIG. 21 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 22 is a flowchart illustrating a method implemented in a communication system, in accordance with one embodiment. The communication system includes a host computer, a base station and a UE which may be those described with reference to FIGS. 17 and 18. For simplicity of the present disclosure, only drawing references to FIG. 22 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

1-12. (canceled)

13. A method, performed by a network node, the method comprising:
handling registration of a User Equipment (UE) to an Internet Protocol Multimedia Subsystem (IMS) network in a communication network;
wherein the UE is performing a handover from a first public land mobile network (PLMN) of a first country or operator to a second PLMN of a second country or operator.

14. The method of claim 13, wherein the handling of the registration comprises enforcing the UE to make a session initiation protocol (SIP) registration, the IMS system being capable of switching off a SIP encryption policy immediately after the UE has entered the second PLMN.

15. The method of claim 13, wherein the handling of the registration comprises initiating a SIP re-INVITE with a session description protocol (SDP) including a UE subscriber identity (ID), a remote party ID, and an indication of a speech codec.

16. The method of claim 13, wherein:
the handling of the registration comprises sending a message to another network node;
the message indicates explicitly or implicitly that a different SIP encryption policy and/or Lawful Intercept (LI) policy is to be used; and
the network node knows by configuration that the second PLMN requires a different SIP encryption policy than currently used.

17. The method of claim 13, further comprising responding to a SIP invite from the UE or a Serving Call Session Control Function (S-CSCF) with an error message in response to detecting that the UE has changed to the second PLMN.

18. The method of claim 13, wherein the network node is of the second PLMN and subject to idle mode mobility and the method further comprises:
receiving a tracking area update (TAU) request from the UE; and
rejecting the TAU request with an indication that the UE shall reconnect followed by the establishment of a protocol data network (PDN) connection to an IMS access point name (APN) and an initial SIP registration over the PDN connection.

19. The method of claim 13, wherein the network node is of the second PLMN and the method comprises detecting a voice bearer release and disconnecting a PDN connection of the UE with an instruction to the UE to reconnect.

20. The method of claim 13, further comprising detecting a PLMN change for the UE.

21. A method, performed by a user equipment (UE), of handling communication of the UE in a communication network, the method comprising:
obtaining an indication that the UE is performing a handover from a first public land mobile network (PLMN) of a first country or operator to a second PLMN of a second country or operator;
changing PLMN and initiating a session initiation protocol (SIP) re-register.

22. The method of claim 21, wherein obtaining the indication comprises determining that the UE is performing the handover or receiving the indication from a network node.

23. A network node comprising:
processing circuitry and memory, the memory storing instructions executable by the processing circuitry whereby the network node is configured to:
handle registration of a User Equipment (UE) to an Internet Protocol Multimedia Subsystem (IMS) network in a communication network,
wherein the UE is performing a handover from a first public land mobile network (PLMN) of a first country or operator to a second PLMN of a second country or operator.

24. The network node of claim 23, wherein to handle the registration the network node is configured to enforce the UE to make a session initiation protocol (SIP) registration, the IMS system being capable of switching off a SIP encryption policy immediately after the UE has entered the second PLMN.

25. The network node of claim 23, wherein to handle the registration the network node is configured to initiate a SIP re-INVITE with a session description protocol (SDP) including a UE subscriber identity (ID), a remote party ID, and an indication of a speech codec.

26. The network node of claim 23, wherein:
to handle the registration the network node is configured to send a message to another network node;
the message indicates explicitly or implicitly that a different SIP encryption policy and/or Lawful Intercept (LI) policy is to be used; and
the network node knows by configuration that the second PLMN requires a different SIP encryption policy than currently used.

27. The network node of claim 23, wherein the network node is further configured to respond to a SIP invite from the UE or a Serving Call Session Control Function (S-CSCF) with an error message in response to detecting that the UE has changed to the second PLMN.

28. The network node of claim 23, wherein:
the network node is of the second PLMN and subject to idle mode mobility;
the network node is further configured to:
receive a tracking area update (TAU) request from the UE; and
reject the TAU request with an indication that the UE shall reconnect followed by the establishment of a protocol data network (PDN) connection to an IMS access point name (APN) and an initial SIP registration over the PDN connection.

29. The network node of claim 23, wherein the network node:
is of the second PLMN; and
is further configured to detect a voice bearer release and disconnect a PDN connection of the UE with an instruction to the UE to reconnect.

30. The network node of claim 23, wherein the network node is further configured to detect a PLMN change for the UE.

31. A user equipment (UE) comprising:
processing circuitry and memory, the memory storing instructions executable by the processing circuitry whereby the UE is configured to:
obtain an indication that the UE is performing a handover from a first public land mobile network (PLMN) of a first country or operator to a second PLMN of a second country or operator;
change PLMN and initiate a session initiation protocol (SIP) re-register.

32. The UE of claim 31, wherein to obtain the indication the UE is configured to determine that the UE is performing the handover or receive the indication from a network node.
